(19) United States
(12) Patent Application Publication
(10) Pub. No.: US 2002/0150809 A1
(43) Pub. Date: Oct. 17, 2002

(54) Fuel cell installation

(76) Inventors: Albert Hammerschmidt, Erlangen (DE); Arno Mattejat, Bubenreuth (DE)

Correspondence Address: LERNER AND GREENBERG, P.A., Post Office Box 2480, Hollywood, FL, 33022-2480, US

(21) Appl. No.: 10/141,681

(22) Filed: May 8, 2002

Related U.S. Application Data
(63) Continuation of application No. PCT/DE00/03767, filed on Oct. 25, 2000.

(30) Foreign Application Priority Data
Nov. 8, 1999 (DE) 199 53 614.7

(51) Int. Cl. H01M 8/02; H01M 8/24; H01M 8/10

(52) U.S. Cl. 429/34; 429/26; 429/32

(57) ABSTRACT

When a fuel cell installation is switched off, there is danger that residual oxygen remains in the fuel cells of the fuel cell installation. The residual oxygen results in undesired oxidations that considerably limit the output and life-time of the fuel cell installation. The aim is therefore to make sure that enough hydrogen remains in the fuel cells to bring the entire oxygen within the fuel cells to an electrochemical reaction when the fuel cell installation is switched off. To this end, the fuel cell installation in which the anode gas chamber adjoining the anodes of the fuel cells is at least twice as big as the cathode gas chamber adjoining the cathodes of the fuel cells.

### CROSS-RELATED TO RELATED APPLICATION

This application is a continuation of copending International application PCT/DE00/03767, filed Oct. 25, 2000 which designated the United States and which was not published in English.

### BACKGROUND OF THE INVENTION

### FIELD OF THE INVENTION

The invention relates to a fuel cell installation having at least one fuel cell block that contains a number of fuel cells each having an anode and a cathode. The anode adjoins an anode-gas chamber and the cathode adjoins a cathode-gas chamber, and it being possible for both the anode-gas chamber and the cathode-gas chamber to be closed off in a gastight manner.

It is known that, during electrolysis of water, the water molecules are broken down by electric current into hydrogen (H₂) and oxygen (O₂). In a fuel cell, inter alia this process takes place in reverse. Electrochemical combining of hydrogen and oxygen to form water forms electric current with a high efficiency and, if pure hydrogen is used as a fuel gas, without the emission of pollutants and carbon dioxide (CO₂).

Even with a technical-grade fuel gas, for example natural gas or coal gas and with air instead of pure oxygen, in which case the air may additionally be enriched with oxygen, a fuel cell generates considerably fewer pollutants and less carbon dioxide than other energy generators that operate with fossil energy carriers.

Technical implementation of the principle of the fuel cell has led to various solutions, specifically with different types of electrolytes and with operating temperatures of between 80° C. and 1000° C. The fuel cells are classified as low-temperature, medium-temperature and high-temperature fuel cells, depending on their operating temperature, and these categories can also be distinguished from one another through different technical embodiments.

An individual fuel cell supplies an operating voltage of at most 1.1 volts. Therefore, a multiplicity of fuel cells are stacked on top of one another and combined to form a fuel cell block. In the specialist literature, a block of this type is also known as a stack. Connecting the fuel cells of the fuel cell block in series allows the operating voltage of a fuel cell installation to be several hundred volts.

A fuel cell contains an electrolyte, to one side of which an anode is fixed and to the other side of which a cathode is fixed. The anode is adjoined by an anode-gas chamber, through which the fuel gas can flow past the anode when the fuel cell is operating. The cathode is adjoined by a cathode-gas chamber, through which oxygen or an oxygen-containing gas can flow past the cathode. The anode of a fuel cell is separated from the cathode of an adjacent fuel cell by a separating element. Depending on the type of fuel cell, the separating element is configured, for example, as a bipolar plate or as a cooling element.

When the fuel cell is operating, the fuel gas flows through the anode-gas chamber to the anode and the oxygen-containing gas flows through the cathode-gas chamber to the cathode. The anode and the cathode are produced, inter alia, from a porous material, so that the fuel gas and the oxygen-containing gas can force their way through the anode or the cathode in each case to the electrolyte. Then, at the electrolyte, they enter into the current-generating electrochemical reaction with one another. When the fuel cell installation is switched off, the supply of gas to both gas chambers is interrupted. However, a quantity of residual gas remains in the fuel cells.

Since, in a fuel cell installation that has been switched off, the fuel cells may be electrically disconnected from the current consumer, an electrochemical voltage may build up within the fuel cell, and a further electrochemical reaction between the hydrogen from the fuel gas and the oxygen from the oxygen-containing gas does not occur. In this state, however, both oxygen and hydrogen may penetrate through the anode or cathode, which are in each case produced from a porous material, and force their way to the electrolyte. Depending on the embodiment of the fuel cell, the oxygen may also pass through the electrolyte. It then also penetrates through the porous anode and therefore enters the anode-gas chamber. Therefore, the residual gas which remains in the fuel cells results in the formation of oxide layers, which have an adverse effect on the internal resistance of the cell, in the anode-gas chamber. A corrosive phenomena may also occur, poisoning the electrolyte and thereby shortening the service life of the fuel cells. Both an increase in the cell internal resistance and the corrosion of components lead to the cell voltage being reduced.

To solve this problem, it is disclosed in German Patent DE 28 36 464 B2 that the supplies of gas to the fuel cell installation can be configured in such a manner that it is reliably ensured that the fuel-gas pressure which is present in the fuel cells is always higher than the pressure of the oxygen-containing gas. This effectively prevents oxygen from passing into the anode-gas chamber. A drawback of a fuel cell installation of this type is that it requires pressure-control mechanisms, which are not only expensive but also cannot reliably ensure that no oxygen will reach the anode-gas chamber even in the event of the fuel cell installation malfunctioning.

Japanese Patent Abstract JP 06333586 proposes that, when the fuel cell installation is switched off, initially the supply of oxygen-containing gas is interrupted, and then an electrical load is used to ensure that the electrochemical reaction at the electrolyte is not interrupted, and that the supply of fuel gas is interrupted only when the cell voltage falls. In this case, the fall in the cell voltage is an indication that virtually all the oxygen has been consumed. Then, substantially only fuel gas remains in the fuel cells. A drawback is that a fuel cell installation of this type requires the gas valves to be controlled, which is likewise complex and susceptible to malfunctioning.

In International Patent Disclosure WO 97/48143 it is proposed that, in order for the fuel cell installation to be switched off, in a first step the supply of the oxygen-containing gas be interrupted, the oxygen partial pressure in the fuel cells be measured, and at a predetermined, low oxygen partial pressure, the supply of fuel gas also be interrupted. In this method too, an electric load is used to maintain the electrochemical reaction and therefore the oxygen consumption. If the oxygen partial pressure in the cathode-gas chamber is low enough, the residual oxygen that remains in the fuel cells, while the electrochemical reaction with the hydrogen from the fuel gas remaining in the fuel cells is maintained, can react completely. This ensures that there is no longer any residual oxygen in the fuel cells. However, this method too disadvantageously requires control of the gas valves, which is complex and not sufficiently resistant to malfunctions.

### SUMMARY OF THE INVENTION

It is accordingly an object of the invention to provide a fuel cell installation which overcomes the above-mentioned disadvantages of the prior art devices of this general type, in which premature aging of the fuel cells caused by residual oxygen remaining in the fuel cells is avoided in a simple way.

With the foregoing and other objects in view there is provided, in accordance with the invention, a fuel cell installation. The fuel cell installation includes at least one fuel cell block containing a plurality of fuel cells having anodes and cathodes, and an anode-gas chamber having a first volume. The anodes of the fuel cells adjoin the anode-gas chamber. A cathode-gas chamber having a second volume is provided. The cathodes of the fuel cells adjoin the cathode-gas chamber. Both of the anode-gas chamber and the cathode-gas chamber can be closed off in a gastight manner. The first volume of the anode-gas chamber in a closed state is at least 1.5 times as great as the second volume of the cathode-gas chamber in the closed state.

The object is achieved by the fuel cell installation of the type described in the introduction in which, according to the invention, the volume of the anode-gas chamber in the closed state is at least twice as great as the volume of the cathode-gas chamber in the closed state.

If a fuel cell installation of this type is operated, for example, with pure hydrogen as the fuel gas and pure oxygen, in volume terms at least twice as much hydrogen remains in the anode-gas chamber as oxygen in the cathode-gas chamber after the fuel cell installation has been switched off. If the supply of the two operating gases is interrupted simultaneously, and if the electrochemical reaction is maintained by an electrical load, the hydrogen from the anode-gas chamber can react with the oxygen from the cathode-gas chamber along the electrolyte. During the electrochemical reaction between the hydrogen and the oxygen to form water, twice as much hydrogen as oxygen is consumed. Since, on account of the size of the gas chambers, there is more than twice as much hydrogen in the anode-gas chamber as oxygen in the cathode-gas chamber, the oxygen is completely consumed, so that, a short time after the fuel cell installation has been switched off, only hydrogen remains in the fuel cells. This effectively prevents oxidation of components of the fuel cells without the fuel cell installation having to be equipped with a control mechanism to switch off the fuel cell installation.

The term anode-gas chamber is understood as meaning a gas chamber that contains the following gas chambers:

a) the anode-gas reaction chamber of at least one anode, and

b) a gas chamber which is formed by the passages and lines connected to the anode-gas chamber, the passages and lines leading from the anode-gas chamber to a closure, which is used to close off the anode-gas chamber.

The term anode-gas reaction chamber of an anode is understood as meaning the gas chamber that directly adjoins the anode. Within the anode-gas reaction chamber, the fuel gas can flow freely over the surface of the porous anode in order then to penetrate into the anode. Feed and discharge lines for the fuel gas are connected to the anode-gas reaction chamber. These lines may be formed, for example, as flexible tubes or lines. However, they may also be configured in the form of passages within the fuel cell block.

In a similar way to the anode-gas chamber, the cathode-gas chamber contains the cathode-gas reaction chamber of at least one cathode and the gas chamber that is formed by the passages or lines connected to the cathode-gas chamber.

The anode-gas chamber and the cathode-gas chamber can be closed off in a gastight manner, for example by shut-off valves that can be closed simultaneously. This is easily ensured, by way of example, by the shut-off valves that delimit the gas volume of the gas chambers being connected to a common circuit or being simultaneously connected by a control unit.

The fuel cell installation is advantageously configured for oxygen operation. During operation, an installation of this type is fed with oxygen as the cathode gas. When pure hydrogen is fed as the fuel gas into the fuel cell installation it is ensured, as described above, that after the fuel cell installation has been switched off no residual oxygen remains within the fuel cells.

However, the fuel cell installation may equally be configured for operation with an oxygen-containing gas, for example air. Furthermore, the fuel cell installations may be configured both for operation with air and alternatively also for operation with oxygen. In the case of a fuel cell installation that is operated with air and to which pure hydrogen is supplied as the fuel gas during operation, the problem described above does not necessarily occur, since only approximately 20% of air is oxygen. However, a fuel cell installation according to the invention which is configured for operation with air allows operation with a gas ballast without there being any risk of the fuel cells being oxidized after the fuel cell installation has been switched off. When a fuel cell installation is operated with the gas ballast, fractions of the anode exhaust gas or all the anode off-gas are returned to the fuel cells as a fuel gas. As a result, there is no accumulation of combustible gas, in particular inert gases, in the anode-gas chamber. This reduces the concentration of the hydrogen in the fuel gas in the anode-gas chamber. However, when the fuel cell installation is switched off, despite the possibly low concentration of hydrogen in the fuel gas, it is always still ensured that, after the fuel cell installation has been switched off and the supply of operating gases has been interrupted, sufficient hydrogen still remains in the anode-gas chamber to completely convert the oxygen from the cathode-gas chamber into an electrochemical reaction.

In an advantageous configuration of the invention, a number of anodes each adjoin an anode-gas chamber, and a number of cathodes each adjoin a cathode-gas chamber. The two numbers do not have to be identical. An anode-gas chamber of this type is formed, for example, by the number of anode-gas reaction chambers which adjoin the anodes, the lines and/or passages situated between the anode-gas reaction chambers and the gas feed and discharge lines leading to the shut-off valves. A combination of a number of anode-gas reaction chambers of this type to form one anode-gas chamber has the advantage that it is not necessary for it to be possible to shut off each anode-gas reaction chamber separately, for example by shut-off valves. In this configuration of the invention, one fuel cell block of a fuel cell installation may be assigned a plurality of anode-gas chambers and cathode-gas chambers. This may be the case, for example, if a fuel gas or an oxygen-containing gas is fed through the fuel cell block in cascaded form.

In an advantageous refinement of the invention, the fuel cell block is assigned only one anode-gas chamber and one cathode-gas chamber. An anode-gas chamber or a cathode-gas chamber of this type contains the gas reaction chambers of all anodes or cathodes of the fuel cell block. In a fuel cell installation of this type, to close off all the gas chambers within the fuel cells of the fuel cell block in a gastight manner, in each case only one valve is required in the feed and discharge lines for the fuel gas and the oxygen-containing gas to and from the fuel cell block.

The anode-gas chamber or the cathode-gas chamber advantageously contains the gas chamber of a gas vessel. Alternatively, the anode-gas chamber and the cathode-gas chamber in each case contain the gas chamber of a gas vessel. The gas vessel is configured in such a way that the gas chamber which it surrounds—together with the other gas chambers assigned to the anode-gas chamber or the cathode-gas chamber—creates the desired volumetric ratio of anode-gas chamber to cathode-gas chamber. In this configuration of the invention, the anode-gas reaction chambers of the fuel cell block may be of structurally identical configuration to the cathode-gas reaction chambers of the fuel cell block. This allows the fuel cell block to be configured with the same geometry as has hitherto been customary, namely with geometrically identical anode-gas reaction chambers and cathode-gas reaction chambers. A gas vessel is merely added to the anode-gas chamber or the cathode-gas chamber. Depending on the size of the gas vessel, the volumetric ratio between the anode-gas chamber and the cathode-gas chamber may be set in such a manner that the fuel cell installation can be switched off as a function of the fuel gas or oxygen-containing gas supplied without there being any risk of corrosion. In this case, the gas vessel may be disposed outside the fuel cell block or may be integrated in the fuel cell block. The gas vessel used may, for example, be what is known as an “air chamber”. An “air chamber” of this type is used in some fuel cell installations to reduce pressure surges.

In an expedient configuration of the invention, the gas vessel is a hydrogen separator or an oxygen separator. A separator of this type is often used in fuel cell installations. In this configuration of the invention, there is no need for a component that is produced specifically to set the desired volumetric ratio. This makes a configuration of this type particularly simple and inexpensive to implement.

In a further advantageous configuration-of the invention, a cooling element is disposed between the anode of a first fuel cell and the cathode of an adjacent fuel cell, in such a manner that the gas chamber between anode and the cooling element is significantly larger than the gas chamber between cathode and cooling element. In the case of a low-temperature fuel cell, a cooling element is used to dissipate the heat generated during the electrochemical reaction from the fuel cell. It is generally disposed between the anode and the cathode, specifically in such a manner that the anode-gas reaction chamber is formed between the cooling element and the anode and the cathode-gas reaction chamber is formed between the cooling element and the cathode. Hitherto, a cooling element of this type has been disposed symmetrically between the cathode and the anode, so that the anode-gas reaction chamber and the cathode-gas reaction chamber are configured to be of the same size. If the cooling element is disposed asymmetrically between the cathode and the anode, the anode-gas reaction chamber and the cathode-gas reaction chamber are configured to be of different sizes. In this way, the configuration of the cooling element can be used to set the volumetric ratio between the anode-gas chamber and the cathode-gas chamber in the desired way without a further component additionally having to be added to the fuel cell installation for this purpose.

The cooling element is expediently configured asymmetrically with regard to the size of the gas chambers. The asymmetric configuration may, for example, consist in the cooling element having a form that is of different shape or different height on its side that faces the anode from its side that faces the cathode. The shape or form of the two sides of the cooling element decisively influences the size of the anode-gas or cathode-gas reaction chamber. Therefore, given different shapes of the two sides of the cooling element, the size of the anode-gas reaction chamber differs from that of the cathode-gas reaction chamber. As a result, it is particularly easy to set the volumetric ratio between anode-gas chamber and cathode-gas chamber in a predetermined way.

A further advantage can be achieved by the fuel cells being proton-conducting electrolyte membrane (PEM) fuel cells. PEM fuel cells are operated at a low operating temperature of approximately 80° C., have a favorable overload behavior and a long service life. Moreover, they behave favorably in the event of rapid load changes and can be operated with air and also with pure oxygen. All these properties make PEM fuel cells particularly suitable for use in the mobile sector, for example for driving vehicles of very diverse kind.

A further preferred embodiment of the invention can be achieved by the invention being modified in such a way that the volume of the anode-gas chamber is at least two times as great as the volume of the cathode-gas chamber. Depending on the operating gas or oxygen-containing gas with which the fuel cell installation is operated, it may be sufficient, to allow the fuel cell installation to be switched off without risks, for the anode-gas chamber to be only at least 1.5 times as large as the cathode-gas chamber. In this configuration of the invention, the fuel cell block may be configured to be slightly smaller than with a volumetric ratio of 1:2.

Other features which are considered as characteristic for the invention are set forth in the appended claims.

Although the invention is illustrated and described herein as embodied in a fuel cell installation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view through a fuel cell having an anode-gas chamber and a cathode-gas chamber according to the invention;

FIG. 2 is a sectional view through a plurality of fuel cells, each having a cooling element; and

FIG. 3 diagrammatically depicts a supply and removal of operating gas to and from the fuel cells.

### DESCRIPTION OF THE PREFERRED EMBODIMENTS

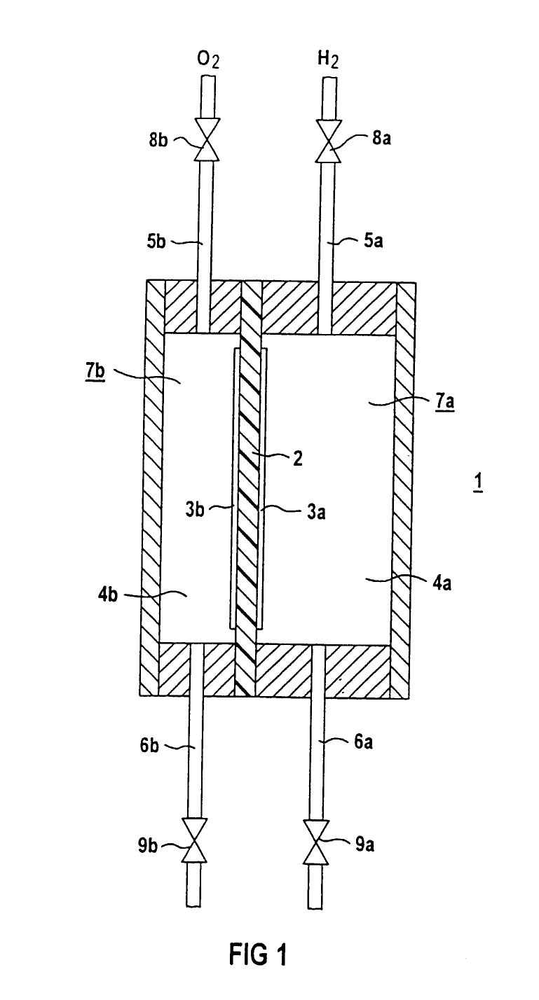

Referring now to the figures of the drawing in detail and first, particularly, to FIG. 1 thereof, there is shown a fuel cell 1 which contains a flat electrolyte 2 and electrodes which are fixed to it, namely an anode 3a and a cathode 3b. An anode-gas reaction chamber 4a assigned to the anode 3a joins the anode 3a. A cathode-gas reaction chamber 4b assigned to the cathode 3b adjoins the cathode 3b. The fuel cell 1, which is configured for operation with pure oxygen O₂ and pure hydrogen H₂, is supplied with hydrogen H₂ through a fuel-gas feed line 5a and with oxygen O₂ through an oxygen feed line 5b. When the fuel cell 1 is operating, a fuel gas flows through the fuel-gas feedline 5a into the anode-gas reaction chamber 4a, where it can pass along the anode 3a and react at the electrolyte 2. The fuel that is not consumed during the process emerges from the anode-gas reaction chamber 4a through the fuel-gas discharge line 6a and is removed from the fuel cell 1. In a similar way, the oxygen passes through the oxygen feedline 5b into the cathode-gas reaction chamber 4b, can penetrate through the cathode 3b to the electrolyte and react at the electrolyte 2. The oxygen that is not consumed during the process is guided out of the cathode-gas reaction chamber 4b through the oxygen discharge line 6b and is removed from the fuel cell 1.

The anode-gas reaction chamber 4a is part of the anode-gas chamber 7a, a gas volume of which is composed of the gas volume of the anode-gas reaction chamber 4a and the gas volume of the fuel-gas feedline 5a and of the fuel-gas discharge line 6a. The volume of the anode-gas chamber 7a is delimited by a fuel-gas feed line valve 8a and a fuel-gas discharge line valve 9a. The volume of the anode-gas chamber 7a is approximately 2½ times as great as the volume of the cathode-gas chamber 7b, which is composed of the total of the volume of the cathode-gas reaction chamber 4b and the volumes of the oxygen feed and discharge lines 5b and 6b, respectively. The volume of the cathode-gas chamber 7b is delimited by an oxygen feedline valve 8b and an oxygen discharge line valve 9b.

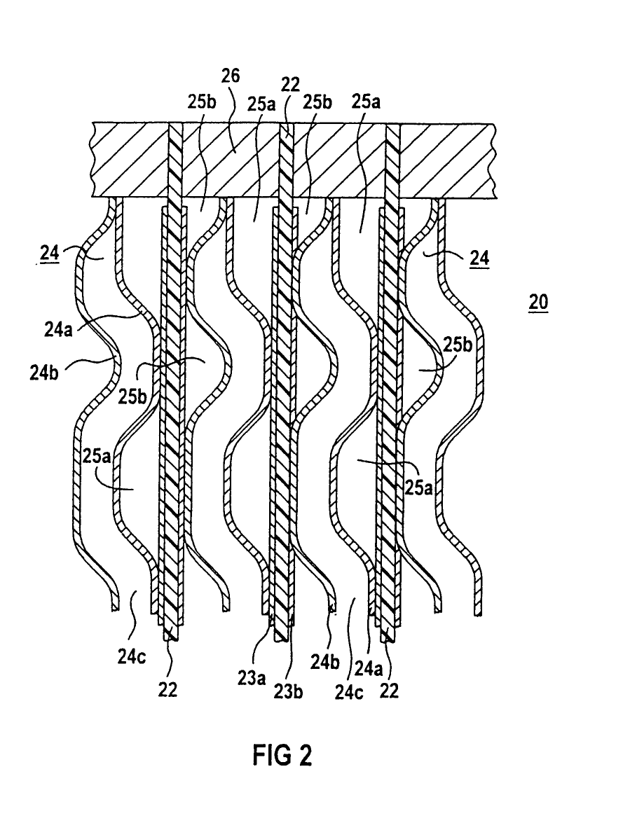

FIG. 2 shows an excerpt of a fuel cell block 20. Three electrolytes 22, as well as anodes 23a and cathodes 23b which bear fixedly against the electrolytes 22, can be seen in this excerpt. A cooling element 24 is in each case disposed between the anode 23a of one fuel cell and the cathode 23b of an adjacent fuel cell. The cooling element 24 contains two plates, namely an anode plate 24a and a cathode plate 24b. The anode 23a and the anode plate 24a of an adjacent cooling element 24 delimit an anode-gas reaction chamber 25a of a fuel cell. The cathode 23b of the fuel cell, together with the cathode plate 24b of the adjacent cooling element 24, delimits a cathode-gas reaction chamber 25b of the fuel cell. The anode-gas reaction chambers 25a and the cathode-gas reaction chambers 25b of the fuel cell block 20 are also delimited by a seal 26, which is partially illustrated in FIG. 2. Feed and discharge lines for the fuel gas and the oxygen-containing gas are incorporated in the seal 26, but are not illustrated in FIG. 2. A volume of the anode-gas reaction chambers 25a and of the cathode-gas reaction chambers 25b are decisively determined by the shape of the cooling elements 24. The anode plates 24a and the cathode plates 24b, between which there is in each case one cooling-water chamber 24c, are shaped in such a way that the volume of the anode-gas reaction chambers 25a is approximately twice as great as the volume of the cathode-gas reaction chambers 25b. In each case a number of anode-gas reaction chambers and cathode-gas reaction chambers are combined to form one anode-gas chamber or one cathode-gas chamber.

The asymmetric shape of the cooling elements 24 ensures in a simple way that, when the fuel cell installation is switched off, approximately twice as much fuel gas remains in the anode-gas chamber as the oxygen-containing gas in the cathode-gas chamber. In this exemplary embodiment, the asymmetry is achieved by the different shape of the anode plate 24a and the cathode plate 24b of the cooling elements 24. This measure, which is easy to implement in configuration terms, ensures that when the fuel cell installation is switched off, there is no risk of corrosion to components of the fuel cells. This applies in particular to a fuel cell installation that is operated with an operating gas in which the oxygen partial pressure of the oxygen-containing gas is no greater or is only slightly greater than the hydrogen partial pressure of the fuel gas.

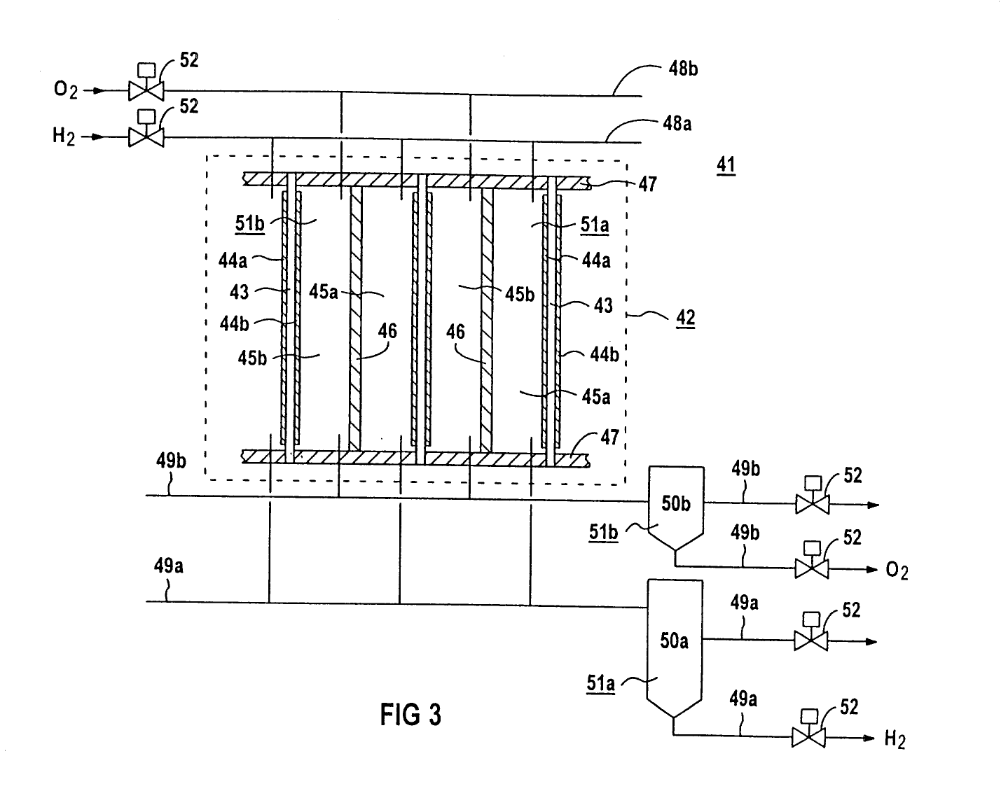

FIG. 3 diagrammatically depicts the structure of a fuel cell installation 41. The fuel cell installation 41 contains a fuel cell block 42 that, for its part, contains a multiplicity of fuel cells. Each of the fuel cells contains an electrolyte 43 and an anode 44a and a cathode 44b. The anodes 44a of all the fuel cells in each case adjoin an anode-gas reaction chamber 45a. The cathodes 44b of all the fuel cells in each case adjoin a cathode-gas reaction chamber 45b. The anode-gas reaction chamber 45a of each fuel cell is delimited by the anode 44a, a separating element 46, which may be configured, for example, as a bipolar plate or as a cooling unit, and a seal 47 disposed around the fuel cells. The fuel cells are supplied with fuel through a fuel feedline 48a. They are supplied with an oxygen-containing gas through the oxygen feedline 48b. The operating gas fuel and the oxygen-containing gas flow through the anode-gas reaction chamber 45a and the cathode-gas reaction chamber 45b, respectively, some of the operating gases being consumed during the electrochemical reaction at the electrolyte 43. The unconsumed part of the fuel gas is guided out of the fuel cells through a fuel discharge line 49a. It then passes into a gas vessel 50a that is configured as a hydrogen separator. The oxygen-containing gas that is not consumed in the electrochemical reaction is guided out of the fuel cells through an oxygen discharge line 49b and passed into a gas vessel 50b, which is configured as an oxygen separator.

In this exemplary embodiment, the fuel cell block 42 has only a single anode-gas chamber 51a. The volume of the anode-gas chamber 51a is composed of the volumes of all the anode-gas reaction chambers 45a of the fuel cell block and of the fuel-gas feedline 48a, the fuel-gas discharge line 49a and the volume surrounded by the gas vessel 50a. The valves 52 can be used to close off both the anode-gas chamber and the cathode-gas chamber in a gastight manner. The-volume of the anode-gas chamber 51a is approximately three times as large as the volume of the cathode-gas chamber 51b, which is configured in a similar manner to the anode-gas chamber 51a. The difference in volume between the two gas chambers is produced by the different size of the gas vessels 50a and 50b. The gas vessel 50a , which is configured as a hydrogen separator, is significantly larger than the gas vessel 50b configured as an oxygen separator.

When the fuel cell installation is switched off, the anode-gas chamber 51a and the cathode-gas chamber 51b are closed off in a gastight manner by the valves 52 which can be closed simultaneously. The electrochemical reaction along the electrolyte 43 of the fuel cell block is maintained by an electrical load, ensuring that it is impossible for an excessively high voltage to build up in the fuel cells. As a result, the hydrogen in the anode-gas chamber 51a and the oxygen in the cathode-gas chamber 51b are consumed until there is virtually no more oxygen left in the cathode-gas chamber 51b. This ensures that, after the fuel cell installation has been switched off, there is virtually no oxygen left in the fuel cells of the fuel cell installation, and there is no risk of oxidation causing premature aging of the components of the fuel cells.

We claim:

1. A fuel cell installation, comprising:
at least one fuel cell block containing a plurality of fuel cells having anodes and cathodes;
an anode-gas chamber having a first volume, said anodes of said fuel cells adjoining said anode-gas chamber; and
a cathode-gas chamber having a second volume, said cathodes of said fuel cells adjoining said cathode-gas chamber, both of said anode-gas chamber and said cathode-gas chamber can be closed off in a gastight manner, said first volume of said anode-gas chamber in a closed state is at least 1.5 times as great as said second volume of said cathode-gas chamber in the closed state.

2. The fuel cell installation according to claim 1, wherein a first number of said anodes adjoin said anode-gas chamber and a second number of said cathodes adjoin said cathode-gas chamber.

3. The fuel cell installation according to claim 1, wherein said fuel cell block is assigned only said anode-gas chamber and only said cathode-gas chamber.

4. The fuel cell installation according to claim 2, wherein said anode-gas chamber contains a gas vessel having a gas chamber formed therein.

5. The fuel cell installation according to claim 4, wherein said gas vessel is a separator selected from the group consisting of hydrogen separators and oxygen separators.

6. The fuel cell installation according to claim 1, wherein:
said fuels cells include a first fuel cell and a second fuel cell adjacent said first fuel cell and each has an anode and a cathode; and
said fuel cell block has a cooling element disposed between said anode of said first fuel cell and said cathode of said second fuel cell adjacent said first fuel cell, said cooling element disposed such that a first gas chamber is formed between said anode of said first fuel cell and said cooling element and a second gas chamber is formed between said cathode of said second fuel cell and said cooling element, said first gas chamber being larger than said second gas chamber.

7. The fuel cell installation according to claim 6, wherein said cooling element is asymmetrically with respect to a size of said first gas chamber and said second gas chamber.

8. The fuel cell installation according to claim 1, wherein said fuel cell block is configured for oxygen operation.

9. The fuel cell installation according to claim 1, wherein said fuel cells are proton-conducting electrolyte membrane fuel cells.

10. The fuel cell installation according to claim 1, wherein said first volume of said anode-gas chamber is at least twice as great as said second volume of said cathode-gas chamber.

11. The fuel cell installation according to claim 2, wherein said cathode-gas chamber contains a gas vessel having a gas chamber formed therein.

12. The fuel cell installation according to claim 11, wherein said gas vessel is a separator selected from the group consisting of hydrogen separators and oxygen separators.

13. The fuel cell installation according to claim 2, wherein said anode-gas chamber and said cathode-gas chamber each contain a gas vessel having a gas chamber formed therein.

14. The fuel cell installation according to claim 13, wherein said gas vessel is a separator selected from the group consisting of hydrogen separators and oxygen separators.
